(19) United States
(12) Patent Application Publication
(10) Pub. No.: US 2025/0220437 A1
(43) Pub. Date: Jul. 3, 2025

(54) UNIQUELY IDENTIFYING AN ENDPOINT THAT CONNECTS TO A NETWORK USING MULTIPLE CHANNELS/BANDS

(71) Applicant: Cisco Technology, Inc., San Jose, CA (US)

(72) Inventors: Laxmi MUKUND, Bangalore (IN); Abhishek KUMAR, Bangalore (IN); Jagadeesh Kumar KAKUMANU, Penuganchiprolu Mandal (IN); Kumari PRIYANKA, Bangalore (IN); Kovuru PRASANTHI, Bengaluru (IN); Samir Yasin VAIDYA, Bangalore (IN); Shree Narasimha MURTHY, San Jose, CA (US)

(73) Assignee: Cisco Technology, Inc., San Jose, CA (US)

(21) Appl. No.: 19/006,859

(22) Filed: Dec. 31, 2024

(30) Foreign Application Priority Data
Dec. 31, 2023 (IN) 202341090353

(51) Int. Cl. H04W 12/55; H04W 12/06; H04W 28/20; H04W 76/15

(52) U.S. Cl. CPC H04W 12/55; H04W 12/06; H04W 28/20; H04W 76/15

(57) ABSTRACT

Uniquely identifying an endpoint that connects to a network using multiple channel/bands may be provided. A client device may begin a first connection with an Access Point (AP). The client device is a multi-Wireless-Fidelity (Wi-Fi) capable device. The client device may generate a Multi-Wi-Fi Device Identifier (MWDI). The client device may send the MWDI to the AP during a four-way handshake for the first connection. The client device may begin a second connection with the AP after establishing the first connection. The client device may send the MWDI to the AP during a four-way handshake for the second connection. The AP may determine, based on the MWDI, that both the first connection and the second connection are originating from a same client device and apply a policy applied to the first connection also to the second connection.

### RELATED APPLICATION

Under provisions of 35 U.S.C. § 119(e), Applicant claims the benefit of Indian Provisional Application No. 20/234,1090353 filed Dec. 31, 2023, which is incorporated herein by reference.

### TECHNICAL FIELD

The present disclosure relates generally to uniquely identifying an endpoint that connects to a network using multiple channel/bands.

### BACKGROUND

In computer networking, a wireless Access Point (AP) is a networking hardware device that allows a Wi-Fi compatible client device to connect to a wired network and to other client devices. The AP usually connects to a router (directly or indirectly via a wired network) as a standalone device, but it can also be an integral component of the router itself. Several APs may also work in coordination, either through direct wired or wireless connections, or through a central system, commonly called a Wireless Local Area Network (WLAN) controller. An AP is differentiated from a hotspot, which is the physical location where Wi-Fi access to a WLAN is available.

Prior to wireless networks, setting up a computer network in a business, home, or school often required running many cables through walls and ceilings in order to deliver network access to all of the network-enabled devices in the building. With the creation of the wireless AP, network users are able to add devices that access the network with few or no cables. An AP connects to a wired network, then provides radio frequency links for other radio devices to reach that wired network. Most APs support the connection of multiple wireless devices. APs are built to support a standard for sending and receiving data using these radio frequencies.

### BRIEF DESCRIPTION OF THE FIGURES

The accompanying drawings, which are incorporated in and constitute a part of this disclosure, illustrate various implementations of the present disclosure. In the drawings:

FIG. 1 is an operating environment for uniquely identifying an endpoint that connects to a network using multiple channel/bands;

FIG. 2 is a diagram illustrating network stacks of a client device;

FIG. 3 illustrates a first device authentication sequence;

FIG. 4 illustrates a second device authentication sequence;

FIG. 5 illustrates a third device authentication sequence;

FIG. 6 is a flow chart of a first method to uniquely identify an endpoint that connects to a network using multiple channel/bands;

FIG. 7 is a flow chart of a second method to uniquely identify an endpoint that connects to a network using multiple channel/bands;

FIG. 8 is a flow chart of a third method to uniquely identify an endpoint that connects to a network using multiple channel/bands; and

FIG. 9 is a block diagram of a computing device.

### DETAILED DESCRIPTION

### Overview

Uniquely identifying an endpoint that connects to a network using multiple channel/bands may be provided. A client device may send a first connection with an Access Point (AP), wherein the client device is a multi-Wireless-Fidelity (Wi-Fi) capable device. The client device may generate a Multi-Wi-Fi Device Identifier (MWDI). The client device may send the MWDI to the AP during a four-way handshake for the first connection. The client device may begin a second connection with the AP after establishing the first connection. The client device may send the MWDI to the AP during a four-way handshake for the second connection. The AP may determine, based on the MWDI, that both the first connection and the second connection are originating from a same client device. The AP may apply a policy applied to the first connection also to the second connection in response to determining that both the first connection and the second connection are originating from the same client device.

An AP may receive, from a client device, multi-Wi-Fi capability information of the client device in a first association request for a first connection. The AP may generate a MWDI for the client device in response to the multi-Wi-Fi capability information indicating that the client device is a multi-Wi-Fi capable device in the first association request. The AP may send the MWDI to the client device during a four-way handshake for the first connection. The AP may receive the MWDI from the client device during the four-way handshake for the first connection as an acknowledgement. The AP may receive, from the client device, the multi-Wi-Fi capability information of the client device in a second association request for a second connection after establishing the first connection. The AP may generate another MWDI for the client device in response to determining that the client device is a multi-Wi-Fi capable device from the multi-Wi-Fi information in the second association request. The AP may send the another MWDI to the client device during a four-way handshake for the second connection. The client device is configured to determine whether to use the another MWDI for the second connection.

In accordance with an example embodiment, a client device may establish a first connection with an AP. The client device may be a multi-Wi-Fi capable device. The client device may begin a second connection with the AP after establishing the first connection. The client device may generate a MWDI comprising a Media Access Control (MAC) address of the first connection. The client device may send the MWDI to the AP during a four-way handshake for the second connection. They AP may determine, based on the MWDI, that both the first connection and the second connection are originating from a same client device and apply a policy applied to the first connection also to the second connection.

Both the foregoing overview and the following example implementations are examples and explanatory only and should not be considered to restrict the disclosure's scope, as described and claimed. Furthermore, features and/or variations may be provided in addition to those described. For example, implementations of the disclosure may be directed to various feature combinations and sub-combinations described in the example implementations.

### Example Implementations

The following detailed description refers to the accompanying drawings. Wherever possible, the same reference numbers are used in the drawings and the following description to refer to the same or similar elements. While implementations of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the appended claims.

A client device may be equipped with a feature referred to as a dual-band Wireless Fidelity (Wi-Fi) or a dual Wi-Fi acceleration. This feature may enable the client device to simultaneously connect to two distinct Wi-Fi networks operating on two different frequency bands, such as 2.4 Ghz, 5 GHZ and/or 6 GHz. For example, when dual-band Wi-Fi is enabled, the client device may connect to and transmit data over two Service Set Identifier (SSIDs) or networks in parallel. In this mechanism, although it is a single device, the client device runs two stacks (different Internet Protocol (IP) and Media Access Control (MAC) address) in parallel across bands, making the client device appear as two separate endpoints to network devices and orchestrators due to its concurrent operation across bands. This may potentially result in application of different policies for the two connections originating from one client device or endpoint. Consequently, it may lead to varying levels of Quality of Service (QoS) between the connections, raise security concerns if threat found from one of the connections where we can't quarantine complete device, and may also result in a lack of proper visibility into a status of the client device.

Privacy has become a top priority for a client device using Wi-Fi service. In addition, the client device may use randomized MAC addresses to connect to the Wi-Fi service. Since, the client device may use a different MAC address for each session, maintaining policy and management history across sessions may be difficult. With dual or multi band Wi-Fi support on the client device, combined with the use of randomized MAC address usage on each Wi-Fi interface, the client device may appear as two or more distinct device on the network side. This may lead to further inconsistent policy enforcement across different connections from the same client device, causing the end-user to experience varying performance across each connection. For example, treating each connection from the same client device as unique may result in individual profiling for each connection, leading to the implementation of different firewalls and QoS parameters for each connection. This may have a significant impact on the end user experience, especially for applications designed to support dual or multi-Wi-Fi acceleration. In such cases, a desired QoS level may not be achieved on one connection, and the client device may end up using only one connection while the other remaining underutilized. This may result in stale connections that consume network resources without delivering the expected throughput and access.

The disclosure provides processes where a client device may share a unique identifier across connections in a secured manner. The unique identifier may be changed at periodic intervals or when the client device may refresh sessions across connections. This way client device privacy may also be maintained. The unique identifier may be shared with an Access Point (AP) during a four-way handshake performed during device authentication.

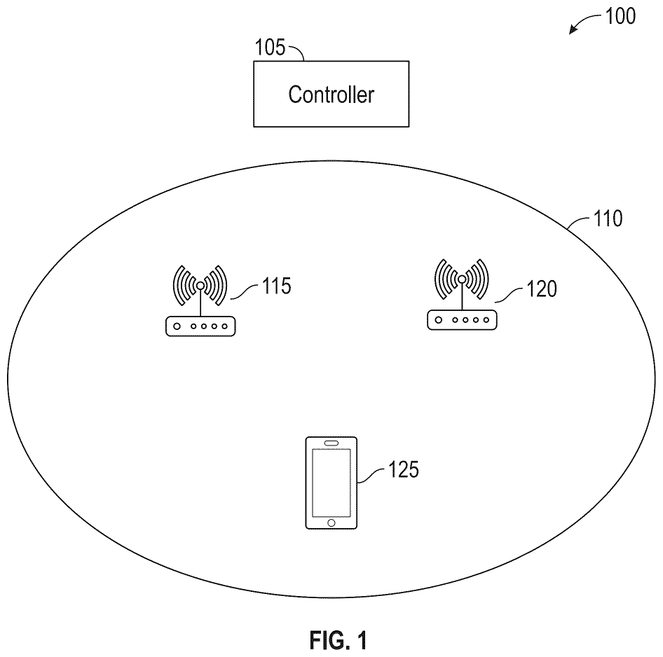

FIG. 1 shows an operating environment 100 for uniquely identifying an endpoint that connects to a network using multiple channel/bands. As shown in FIG. 1, operating environment 100 may comprise a controller 105, and a coverage environment 110. Coverage environment 110 may comprise, but is not limited to, a Wireless Local Area Network (LAN) (WLAN) comprising a plurality of APs that may provide wireless network access (e.g., access to the WLAN for client devices). The plurality of APs may include a first AP 115 and a second AP 120. The plurality of APs may provide wireless network access to a client device 125 as it moves within coverage environment 110.

Client device 125 may support a dual-band Wi-Fi or a Dual Wi-Fi acceleration functionality that may enable client device 125 to simultaneously connect to two distinct Wi-Fi networks operating on different frequency bands, such as 2.4 Ghz, 5 GHz and/or 6 GHz. In examples, when the dual-band Wi-Fi is enabled on client device 125, it can connect and send data on two SSIDs/networks in parallel.

Client device 125 may comprise, but are not limited to, a smart phone, a Head Mounted Device (HMD), a mice, a keyboard, a personal computer, a tablet device, a mobile device, a telephone, a remote control device, a set-top box, a digital video recorder, an Internet-of-Things (IoT) device, a network computer, a router, Augmented Reality (AR)/Virtual Reality (VR)/XR devices, or other similar microcomputer-based device. Each of the plurality of APs may be compatible with specification standards such as, but not limited to, the Institute of Electrical and Electronics Engineers (IEEE) 802.11 specification standard for example.

Each of first AP 115, second AP 120, and client device 125 may use Multi-Link Operation (MLO) where they simultaneously transmit and receive across different bands and channels by establishing two or more links to two or more AP radios. These bands may comprise, but are not limited the 2 GHz band, the 5 GHz band, the 6 GHz band, and the 60 GHz band.

Controller 105 may comprise a Wireless LAN Controller (WLC) and may provision and control coverage environment 110 (e.g., a WLAN). Controller 105 may allow client device 125 to join coverage environment 110. In some implementations of the disclosure, controller 105 may be implemented by a Digital Network Architecture Center (DNAC) controller (i.e., a Software-Defined Network (SDN) controller.

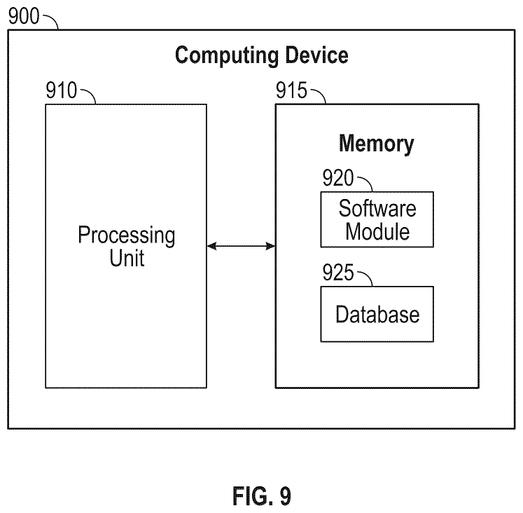

The elements described above of operating environment 100 (e.g., controller 105, first AP 115, second AP 120, or client device 125) may be practiced in hardware and/or in software (including firmware, resident software, micro-code, etc.) or in any other circuits or systems. The elements of operating environment 100 may be practiced in electrical circuits comprising discrete electronic elements, packaged or integrated electronic chips containing logic gates, a circuit utilizing a microprocessor, or on a single chip containing electronic elements or microprocessors. Furthermore, the elements of operating environment 100 may also be practiced using other technologies capable of performing logical operations such as, for example, AND, OR, and NOT, including but not limited to, mechanical, optical, fluidic, and quantum technologies. As described in greater detail below with respect to FIG. 9, the elements of operating environment 100 may be practiced in a computing device 900.

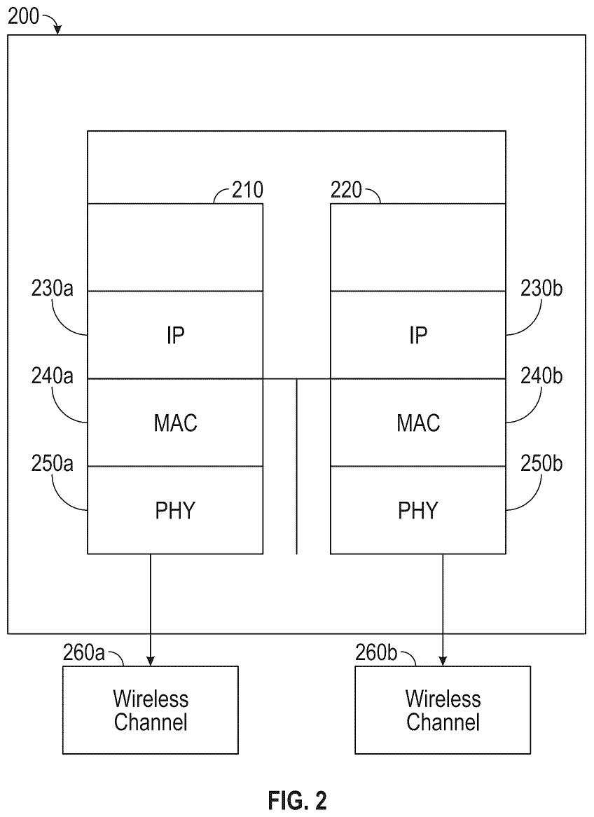

FIG. 2 is a diagram illustrating network stacks 200 of client device 125. As shown in FIG. 2, client device 125 may include multiple network stacks, for example, a first network stack 210 and a second network stack 220. First network stack 210 may include a first IP layer 230a, a first MAC layer 240a, and a first Physical (PHY) layer 250a. Second network stack 220 may include a second IP layer 230b, a second MAC layer 240b, and a second PHY layer 250b. First IP layer 230a may be associated with a first IP address and first MAC layer 240a may be associated with a first MAC address. Second IP layer 230b may be associated with a second IP address and second MAC layer 240b may be associated with a second MAC address. The first IP address may be different from the second IP address. In addition, the second MAC address may be different from the first MAC address.

First network stack 210 may be used to form a first wireless channel 260a and second network stack 220 may be used to form a second wireless channel 260b. When enabled, first wireless channel 260a and second wireless channel 260b may allow client device 125 to make two distinct connections to simultaneously link up with two distinct networks that operate on two different frequency bands, such as 2.4 GHz, 5 GHZ, and/or 6 GHz. For example, client device 125 may, for a gaming application, make one connection to a gaming server over a first connection and another connection for the player.

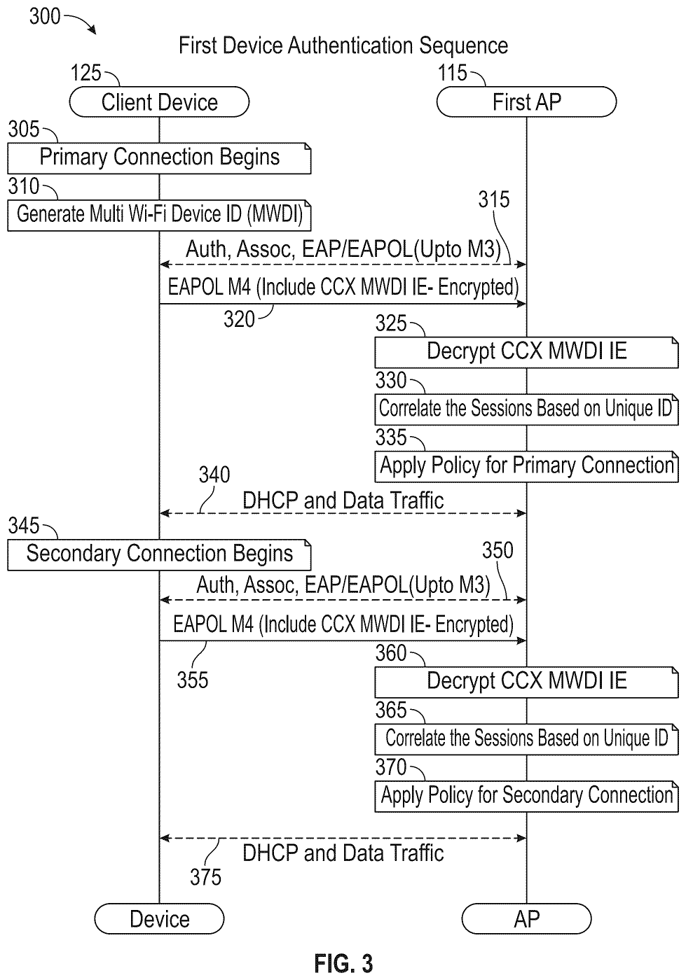

FIG. 3 illustrates a first device authentication sequence 300. Stages of first device authentication sequence 300. In examples, first device authentication sequence 300 may be performed between client device 125 that supports a dual-band Wi-Fi or a dual Wi-Fi acceleration enabling client device 125 to simultaneously form two connections. A first connection formed between client device 125 and first AP 115 may be referred to as a primary connection and a second connection formed between client device 125 and first AP 115 may be referred to as a secondary connection. The secondary connection may be formed after formation of the primary connection. In some examples, the first connection and second connection may be formed between client device 125 and two different APs. In addition, the first connection and second connection may be formed in two different frequency bands and with two different networks.

At stage 305 of first device authentication sequence 300, client device 125 may begin forming the primary connection. For example, first network stack 210 may be activated and client device 125 may scan for available networks to connect to by sending probe request messages. First AP 115 may respond with a probe response message listing a network name (that is, a SSID) and other connection details, for example, encryption type, channel, and signal strength. In some examples, first AP 115 may provide the SSID and connection details for the SSID in a beacon. Client device 125 may begin establishing the primary connection using a built-in or randomized MAC address associated with first MAC layer 240a of first network stack 210.

At stage 310 of first device authentication sequence 300, client device 125 may generate a Multi-Wi-Fi Device Identifier (MWDI). In some examples, the MWDI may only be generated when client device 125 may support the dual-band Wi-Fi or the dual Wi-Fi acceleration. The MWDI may be of a pre-determined length, for example, 48 bits, 6 bytes, or 16 bytes and may be unique to client device 125. In some examples, the MWDI may be a random or a pseudo-random number generated by a random number generator. For example, client device 125 may create the MWDI by taking first 16 bytes of a SHA256 hashing algorithm with seed being a timestamp.

At stage 315 of first device authentication sequence 300, client device 125 and first AP 115 may perform authentication, association, and a partial four-way handshake for the primary connection. For example, client device 125 may send an authentication request to first AP 115 to be authenticated with first AP 115 for the primary connection. Client device 125 may provide a pre-shared key (that is, a password) for the authentication. This key may be used to generate encryption keys, also referred to as a Master Session Key (MSK) for a secure communication. For example, the MSK may be used to generate a Pairwise Master Key (PMK) at each of client device 125 and first AP 115 for the primary connection.

After successful authentication, client device 125 may send an association request to first AP 115. First AP 115 may respond with an association response which may assign a unique Identifier (ID) to client device 125. The association may allow first AP 115 to track and route data to and from client device 125 for the primary connection. During association, client device 125 and first AP 115 may negotiate data rates and encryption settings for the primary connection. After the association, the four-way handshake may ensue to generate session encryption keys for the primary connection. The data encryption keys may include Pairwise Transient Key (PTK) and Group Temporal Key (GTK) that may be generated from the PMK. The four-way handshake may be performed using an Extensible Authentication Protocol (EAP) and may also be referred to as an EAP over LAN (EAPOL). The four-way handshake may facilitate generation of the PTK form the PMK.

For the four-way handshake, first AP 115 may send a first message (M1) that may include an Authenticator Number Used Once (Anonce) to client device 125. The Anonce may be a random or a pseudo-random number generated at first AP 115. After receiving the Anonce, client device 125 may generate its PTK. Client device 125 may generate the PTK from the PMK, the Anonce, a Supplicant Number Used Once (Snonce), a MAC address of client device 125, and a MAC address of first AP 115. The Snonce may also be a random or a pseudo-random number generated at client device 125.

Client device 125, in response to receiving the Anonce, may send a second message (M2) that may include the Snonce to first AP 115. Since client device 125 may already have generated its PTK, it may protect the Snonce through a Message Integrity Code (MIC) generated using the PTK. After receiving the Snonce, first AP 115 may generate its PTK using the PMK, the Anonce, the Snonce, the MAC address of client device 125, and the MAC address of first AP 115. Once having generated its PTK, first AP 115 may validate the MIC to ensure that the Snonce received from client device 125 is authentic. First AP 115 may also generate the GTK. First AP 115 may then send a third message (M3) that may include the GTK to client device 125. The GTK may also be protected by the MIC. Client device 125 may receive, validate, and install the GTK. After installing the GTK, client device 125 may send a fourth message (M4) that may include an acknowledgement to first AP 115 acknowledging the receipt of the GTK. Sending the fourth message (M4) may mark conclusion of the four-way handshake.

At stage 320 of first device authentication sequence 300, client device 125 may send the MWDI of client device 125 to first AP 115 in the fourth message (M4) of the four-way handshake for the primary connection. The MWDI may be included in an encrypted Information Element (IE) in the fourth message (M4). The IE may be vendor specific, for example, a Cisco Compatible Extension (CCX) MWDI IE. The CCX MWDI IE may be encrypted, for example, with PTK or GTK, before being sent to client device 125 in the fourth message (M4).

At stage 325 of first device authentication sequence 300, first AP 115 may decrypt the CCX MWDI IE. First AP 115 may decrypt the CCX MWDI IE using its PTK or GTK to uncover the MWDI for client device 125. At stage 330 of first device authentication sequence 300, first AP 115 may correlate sessions based on the unique ID of client device 125. At stage 335 of first device authentication sequence 300, first AP 115 may apply a policy for the primary connection. The policy may be device specific for all the sessions originating from client device 125 for the primary connection. The policy may be a network policy providing a predetermined QoS level for client device 125.

Once the policy is applied to the primary connection, at stage 340 of first device authentication sequence 300, a Dynamic Host Configuration Protocol (DHCP) configuration and data transmission may ensue. During the DHCP configuration, first AP 115 may assign an IP address to client device 125. Client device 125 may use this IP address to identify itself and access the network. Now since client device 125 is authenticated, associated, and has an IP address, it can send and receive data using the primary connection. Data sent from client device 125 to first AP 115 may be encrypted, and first AP 115 may decrypt and forward it to an appropriate destination. Data from the network may be received by first AP 115, encrypted, and sent to client device 125.

After establishing the primary connection, at stage 345 of first device authentication sequence 300, client device 125 may begin forming a secondary connection. For example, second network stack 220 may be activated and client device 125 may scan for available networks by sending probe request messages. Client device 125 may then select a network to connect to from the available networks through second network stack 220. Client device 125 may begin establishing the secondary connection using a built-in or randomized MAC address associated with second MAC layer 240b of second network stack 220. In addition, the secondary connection may be formed in a second frequency band. The second frequency band may be different from a first frequency band of the primary connection.

At stage 350 of first device authentication sequence 300, client device 125 may authenticate, associate, and exchange up to the third message (M3) of the four-way handshake with first AP 115 for the secondary connection. At stage 355 of first device authentication sequence 300, client device 125 may send the fourth message (M4) of the four-way handshake for the secondary connection. The fourth message (M4) may include the encrypted CCX MWDI IE. After receiving the encrypted CCX MWDI IE from client device 125, first AP 115, at stage 360 of first device authentication sequence 300, may decrypt the encrypted CCX MWDI IE to uncover the MWDI of client device 125.

At stage 365 of first device authentication sequence 300, first AP 115 may correlate sessions based on the unique ID of client device 125. At stage 370 of first device authentication sequence 300, first AP 115 may apply the policy for the secondary connection. The policy applied to the secondary connection may be the same policy that was applied for the primary connection. First AP 115 may be able to determine that the secondary connection also originated from client device 125 based on the MWDI sent in the fourth message (M4) of the four-way handshake for the secondary connection, and hence apply the same policy that was applied to the primary connection that originated from same client device 125. Thus, first AP 115 may apply the same policy to multiple connections originating from same client device 125 ensuring the same QoS across multiple connections. After applying the policy for the secondary connection at stage 370, at stage 375 of first device authentication sequence 300, first AP 115 and client device 125 may set up a DHCP and start data traffic via the secondary connection.

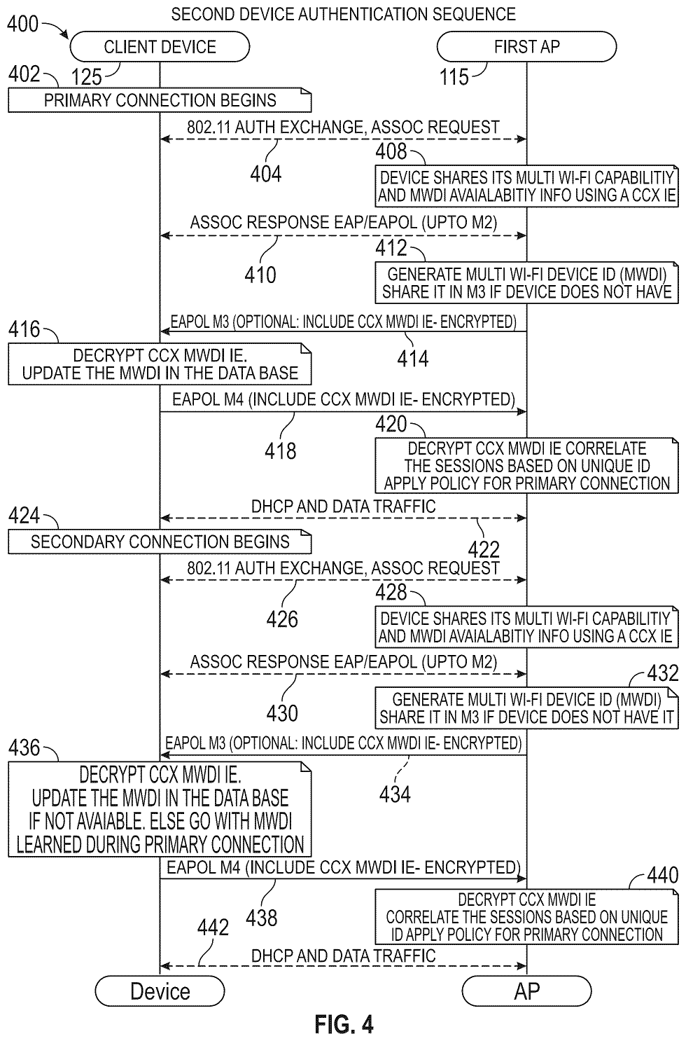

FIG. 4 illustrates a second device authentication sequence 400. Stages of second device authentication sequence 400 may be performed between client device 125 that supports dual-band Wi-Fi or dual Wi-Fi acceleration enabling client device 125 to simultaneously form two connections, that is, a primary connection and a secondary connection.

At stage 402 of second device authentication sequence 400, the primary connection may begin at client device 125. For example, first network stack 210 of client device 125 may be activated and it may scan for available networks by sending probe request messages. First AP 115 may respond with a probe response message listing a network name (that is, a SSID) and other connection details, for example, encryption type, channel, and signal strength.

At stage 404 of second device authentication sequence 400, client device 125 may perform authentication and send an association request to first AP 115. For example, client device 125 may send an authentication request to first AP 115 to be authenticated with the network. Client device 125 may provide a pre-shared key (that is, a password) for authentication. This key may be used to generate a MSK for a secure communication. The MSK may be used to generate a PMK at each of client device 125 and first AP 115. After successful authentication, client device 125 may send an association request to first AP 115.

At stage 408 of second device authentication sequence 400, client device 125 may share its multi-Wi-fi capability and MWDI availability information with first AP 115. The multi-Wi-fi capability and MWDI availability information may be share in an IE that may be vendor specific, for example, a CCX IE. In examples, the CCX IE comprising the multi-Wi-fi capability and the MWDI availability information may be included in the association request frame of the primary connection. The MWDI availability information may indicate whether client device 125 may possess an MWDI.

At stage 410 of second device authentication sequence 400, first AP 115 may send an association response in response to the association request completing the association. During the association, client device 125 and first AP 115 may negotiate data rates and encryption settings for the primary connection. After successful association, a four-way handshake may ensue to generate session encryption keys for the primary connection. First AP 115 and client device 125 may exchange up to the second message (M2) of the four-way handshake for the primary connection.

At stage 412 of second device authentication sequence 400, first AP 115 may generate a MWDI for client device 125 may send it to client device 125 in the third message (M3) of the four-way handshake for the primary connection if client device 125 does not have a MWDI. If client device 125 has an MWDI, then first AP 115 may use the existing MWDI. First AP 115 may determine whether client device 125 has a MWDI from the MWDI availability information received from client device 125 in the association request.

At stage 414 of second device authentication sequence 400, first AP 115 may send the third message (M3) of the four-way handshake for the primary connection. The third message (M3) may also include an encrypted IE comprising the MWDI. The IE may be device specific, for example, a CCX MWDI IE.

At stage 416 of second device authentication sequence 400, client device 125 may decrypt the encrypted CCX MWDI IE to uncover the MWDI. In addition, client device 125 may update the MWDI in its data base. For example, if client device 125 does not have an existing MWDI in its data base, then it may update the data base with the MWDI received from first AP 115. If client device 125 already has an existing MWDI in the data base, then it can ignore the MWDI received from first AP 115.

At stage 418 of second device authentication sequence 400, client device 125 may send the fourth message (M4) of the four-way handshake of the primary connection. The fourth message (M4) may include an encrypted IE, for example, a CCX MWDI IE, comprising the MWDI of client device 125. Client device 125 may send the MWDI in the fourth message (M4) as an acknowledgement of acquiring a MWDI for client device 125.

At stage 420 of second device authentication sequence 400, first AP 115 may decrypt the CCX MWDI IE. In addition, first AP 115 may correlate sessions based on the unique ID of client device 125 and may apply a policy for the primary connection. The policy may be device specific for all the sessions originating from client device 125 for the primary connection. The policy may be a network policy providing a predetermined QoS.

Once the policy is applied to the primary connection, at stage 422 of second device authentication sequence 400, DHCP configuration and data transmission may ensue. During the DHCP configuration, first AP 115 may assign an IP address to client device 125. Client device 125 may use this IP address to identify itself and access the network. Now since client device 125 is authenticated, associated, and has an IP address, it can send and receive data over using the primary connection. Data sent form client device 125 to first AP 115 may be encrypted, and first AP 115 may decrypt and forward it to an appropriate destination. Data from the network may be received by first AP 115, encrypted, and sent to client device 125.

After establishing the primary connection, at stage 424 of second device authentication sequence 400, client device 125 may begin forming or establishing the secondary connection. For example, second network stack 220 may be activated and client device 125 may scan for an available network by sending probe request messages. First AP 115 may respond with a probe response message listing a network name (that is, a SSID) and other connection details, for example, encryption type, channel, and signal strength.

At stage 426 of second device authentication sequence 400, client device 125 may perform authentication and send an association request to first AP 115 for the secondary connection. For example, client device 125 send an authentication request to first AP 115 to be authenticated with the network. Client device 125 may provide a pre-shared key (that is, a password) for authentication. This key may be used to generate a MSK for a secure communication over the secondary connection. The MSK may be used to generate a PMK at each of client device 125 and first AP 115. After successful authentication, client device 125 may send an association request to first AP 115.

At stage 428 of second device authentication sequence 400, client device 125 may share its multi-Wi-fi capability and MWDI availability information using a CCX IE with first AP 115. In examples, the CCX IE comprising the multi-Wi-fi capability and the MWDI availability information may be included in the association request for the secondary connection.

At stage 430 of second device authentication sequence 400, first AP 115 may send an association response in response to the association request concluding the association. During the association, client device 125 and first AP 115 may negotiate data rates and encryption settings for the secondary connection. After the association, a four-way handshake may ensue to generate session encryption keys for the secondary connection. First AP 115 and client device 125 may exchange up to the second message (M2) of the four-way handshake.

At stage 432 of second device authentication sequence 400, first AP 115 may generate another MWDI for client device 125 and may share it in the third message (M3) of the four-way handshake with client device 125 if client device 125 does not have it. First AP 115 may determine whether client device 125 has a MWDI from the MWDI availability information received during the association request for the secondary connection.

At stage 434 of second device authentication sequence 400, first AP 115 may send the third message (M3) of the four-way handshake of the secondary connection. The third message (M3) may also include an encrypted CCX MWDI IE comprising the MWDI in response to first AP 115 determining that client device 125 does not have the MWDI.

At stage 436 of second device authentication sequence 400, client device 125 may decrypt the CCX MWDI IE to uncover the MWDI. In addition, client device 125 may update the MWDI in its data base if there is no MWDI is not available in the data base. If there is an MWDI in the database from the primary connection, then client device 125 may not update the database with the MWDI uncovered at stage 436.

At stage 438 of second device authentication sequence 400, client device 125 may send the fourth message (M4) of the four-way handshake. The fourth message (M4) may also include an encrypted CCX MWDI IE comprising the MWDI of client device 125 as an acknowledgement of existence or receipt of an MWDI.

At stage 440 of second device authentication sequence 400, first AP 115 may decrypt the CCX MWDI IE. In addition, first AP 115 may correlate sessions based on the unique ID of client device 125 and may apply a policy for the secondary connection. As discussed above, the policy applied to the secondary connection may be the same policy that was applied for the primary connection. First AP 115 may be able to determine that the secondary connection also originated from client device 125 based on the MWDI sent in the fourth message (M4) of the four-way handshake for the secondary connection. Thus, first AP 115 may apply the same policy to multiple connections originating from same client device 125 ensuring the same QoS across multiple connections.

Once the policy is applied to the secondary connection, at stage 442 of second device authentication sequence 400, a DHCP configuration and data transmission may ensue. During the DHCP configuration, first AP 115 may assign an IP address to client device 125 for the secondary connection. Client device 125 may use this IP address to identify itself and access the network for the secondary connection. Now since client device 125 is authenticated, associated, and has an IP address, it can send and receive data using the secondary connection. Data sent form client device 125 to first AP 115 may be encrypted, and first AP 115 may decrypt and forward it to an appropriate destination. Data from the network may be received by first AP 115, encrypted, and sent to client device 125.

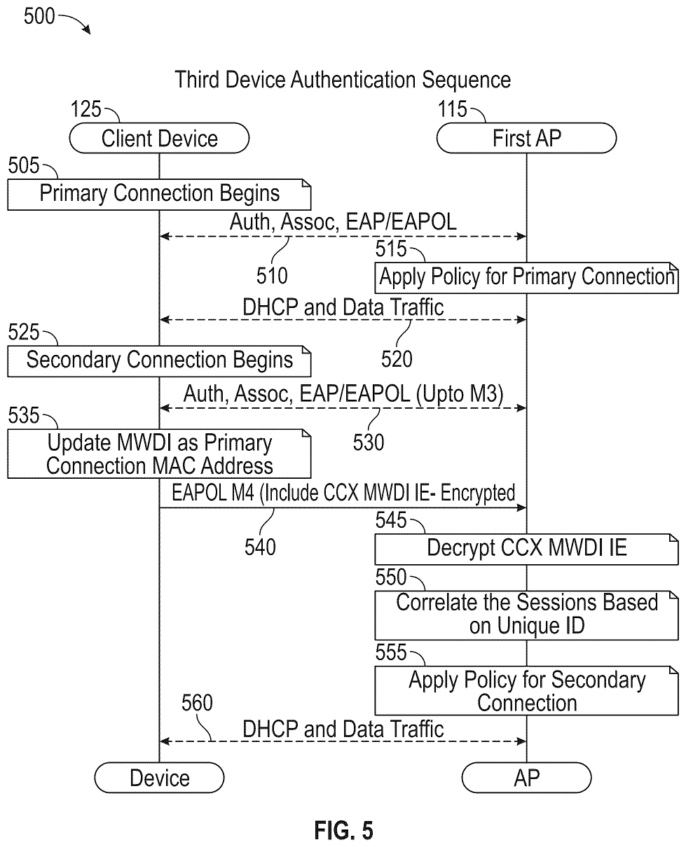

FIG. 5 illustrates a third device authentication sequence 500. Stages of third device authentication sequence 500 may be performed between client device 125 that supports a dual-band Wi-Fi or a dual Wi-Fi acceleration enabling client device 125 to simultaneously form two connections. The two connections may include a primary connection and a secondary connection formed in a first frequency band and a second frequency band respectively.

At stage 505 of third device authentication sequence 500, client device 125 may begin forming the primary connection. For example, first network stack 210 may be activated and it may scan for available networks by sending probe request messages. First AP 115 may respond with a probe response message listing a network name (that is, a SSID) and other connection details, for example, encryption type, channel, and signal strength. Client device 125 may elect to join the network.

After client device 125 begins the primary connection, at stage 510 of third device authentication sequence 500, client device 125 may authenticate, associate, and perform the four-way handshake with first AP 115 for the primary connection. At stage 515 of third device authentication sequence 500, first AP 115 may apply a policy for the primary connection. As discussed above, the policy may be applied to ensure a certain level of QoS for client device 125. After applying the policy for the primary connection at stage 515, at stage 520 of third device authentication sequence 500, first AP 115 may set up a DHCP and start data traffic with client device 125 over the primary connection.

After establishing the primary connection, at stage 525 of third device authentication sequence 500, client device 125 may begin forming the secondary connection. For example, second network stack 220 may be activated and client device 125 may scan for available networks by sending probe request messages. Client device 125 may then select a network to connect to from the available networks through second network stack 220.

Once client device 125 begins the secondary connection, at stage 530 of third device authentication sequence 500, client device 125 may authenticate, associate, and exchange up to the third message (M3) of the four-way handshake with first AP 115 for the secondary connection. At stage 535 of third device authentication sequence 500, client device 125 may update MWDI as a primary connection MAC address. The primary connection MAC address may a MAC address associated with first MAC layer 240a of first network stack 210.

At stage 540 of third device authentication sequence 500, client device 125 may send the fourth message (M4) of the four-way handshake for the secondary connection. The fourth message (M4) may include the encrypted CCX MWDI IE. After receiving the encrypted CCX MWDI IE from client device 125, first AP 115, at stage 545 of third device authentication sequence 500, may decrypt the encrypted CCX MWDI IE to uncover the MWDI of client device 125.

At stage 550 of third device authentication sequence 500, first AP 115 may correlate sessions of the secondary connection based on the unique ID of client device 125. At stage 555 of third device authentication sequence 500, first AP 115 may apply the policy for the secondary connection. The policy applied to the secondary connection may be the same policy that was applied for the primary connection. First AP 115 may be able to determine that the secondary connection also originated from client device 125 based on the primary connection MAC address sent as the MWDI in the fourth message (M4) during the four-way handshake for the secondary connection. After applying the policy for the secondary connection at stage 555, at stage 560 of third device authentication sequence 500, first AP 115 may set up a DHCP and start data traffic with client device 125 over the secondary connection.

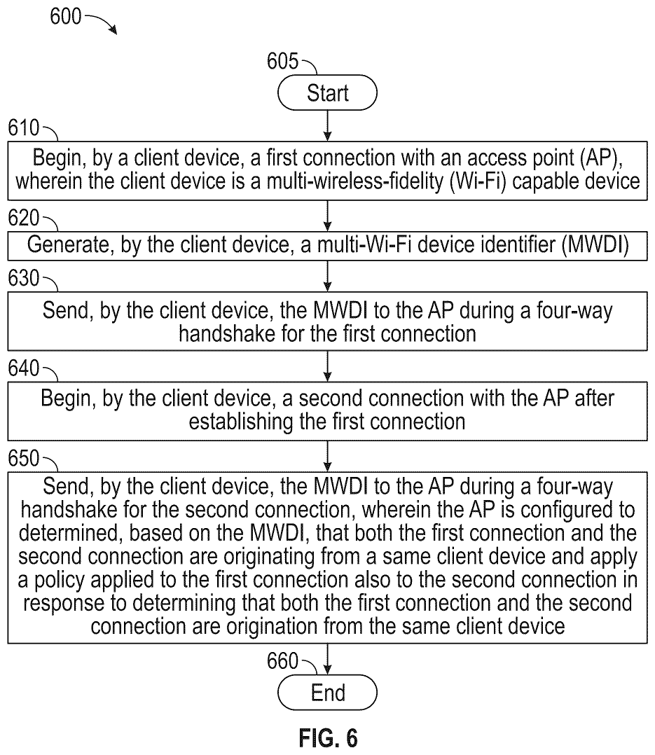

FIG. 6 is a flow chart setting forth the general stages involved in a first method 600 consistent with implementations of the disclosure for uniquely identifying an endpoint that connects to a network using multiple channel/bands. First method 600 may be implemented using first AP 115 and client device 125 as described in more detail above with respect to FIG. 1 and FIG. 2. Ways to implement the stages of first method 600 will be described in greater detail below.

First method 600 may begin at starting block 605 and proceed to stage 610 where client device 125 may begin a first connection with first AP 115. Client device 125 may be is a multi-Wi-Fi capable device. That is, client device 125 may be capable of forming two connections in two different frequency bands. As discussed above, to begin the first connection (or a primary connection), first network stack 210 may be activated and client device 125 may scan for available networks to connect to by sending probe request messages. First AP 115 may respond with a probe response message providing a network name (that is, a SSID) and other connection details, for example, encryption type, channel, and signal strength.

After beginning the first connection with first AP 115 at stage 610, first method 600 may proceed to stage 620 where client device 125 may generate a MWDI. The MWDI may be of a pre-determined length, for example, 48 bits or 6 bytes and may be unique to client device 125. In some examples, the MWDI may be a random or a pseudo-random number generated by a random number generator at client device 125. The MWDI may be changed periodically to increase network security.

Once having generated the MWDI at stage 620, first method 600 may proceed to stage 630 where client device 125 may send the MWDI to first AP 115 during a four-way handshake for the first connection. As discussed above, after generating the MWDI, client device 125 may perform authentication and association processes with first AP 115. After completing association process, client device 125 may start the four-way handshake to create encryption keys for the first connection. The four-way handshake may include: first AP 115 sending an Anonce to client device 125 in a first message (M1), client device 125 then sending a Snonce to first AP 115 in a second message (M2), first AP 115 sending a GTK to client device 125 in a third message (M3), and finally client device 125 sending an acknowledgement to first AP 115 in a fourth message (M4). Client device 125 may send the MWDI in the fourth message (M4) of the four-way handshake of the first connection. The MWDI may be included in an encrypted IE, for example, an encrypted CCX MWDI IE.

After sending the MWDI to first AP 115 at stage 630, first method 600 may proceed to stage 640 where client device 125 may begin a second connection with first AP 115 after establishing the first connection. Second connection may be formed using second network stack 220 of client device 125. By virtue of being a dual-band Wi-Fi capable device, client device 125 may form two different connections on two different bands. For example, after establishing the first connection, client device 125 may begin formation of the second connection. The second connection may be formed in a second frequency band. The second frequency band may be different from the first frequency band in which the first connection may be established. In some examples, the first connection may be associated with a first network and the second connection may be associated with a second network, the second network being different from the first network.

Once having begun the second connection at stage 640, first method 600 may proceed to stage 650 where client device 125 may send the MWDI to first AP 115 during a four-way handshake for the second connection. Client device 125 may send the MWDI in the fourth message (M4) of the four-way handshake of the second connection. The MWDI may be included in an encrypted IE, for example, an encrypted CCX MWDI IE.

First AP 115 may be configured to determine, based on the MWDI, that both the first connection and the second connection are originating from a same client device 125. First AP 115 apply a policy applied to the first connection also to the second connection in response to determining that both the first connection and the second connection are originating from same client device 125. Thus, both the first connection and the second connection, that may be originating from same client device 125 may receive a same level of treatment or same level of QoS. After applying the same policy to the second connection that was applied to the first connection, first method 600 may terminate at END stage 660.

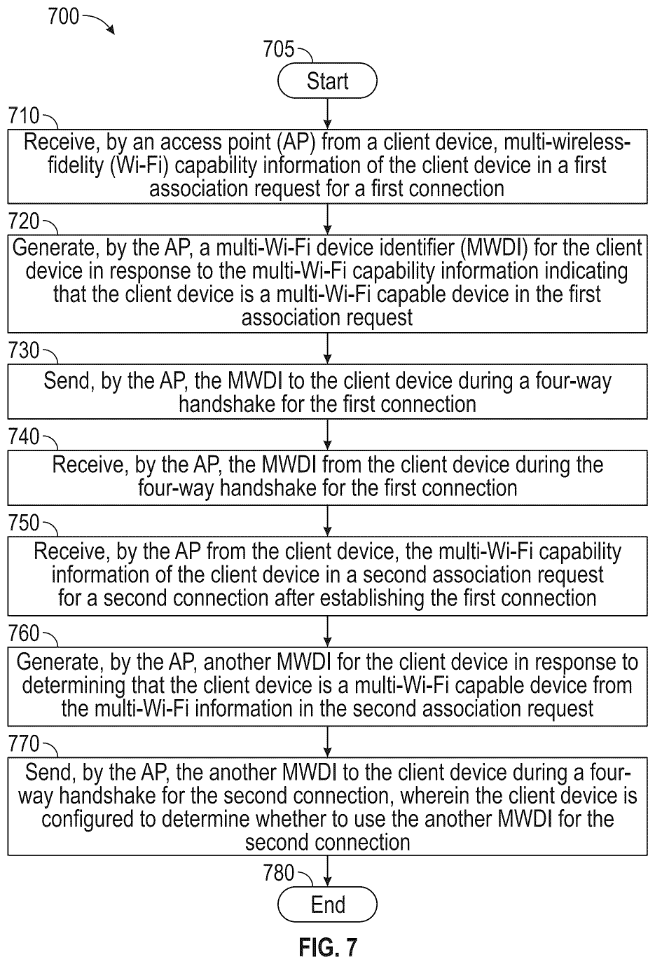

FIG. 7 is a flow chart setting forth the general stages involved in a second method 700 consistent with implementations of the disclosure for uniquely identifying an endpoint that connects to a network using multiple channel/bands. Second method 700 may be implemented using first AP 115 and client device 125 as described in more detail above with respect to FIG. 1 and FIG. 2. Ways to implement the stages of second method 700 will be described in greater detail below.

Second method 700 may begin at starting block 705 and proceed to stage 710 where client device 125 may receive multi-Wi-Fi capability information of client device 125 in a first association request for a first connection from client device 125. The multi-Wi-Fi capability information may be received in an encrypted IE in an association or a re-association frame of the first connection. The IE may be vendor specific. First AP 115 may also receive information regarding availability of an MWDI in the association or the re-association frame of the first connection. For example, client device 125 may send an MWDI, if available, in the association or the re-association frame of the first connection to first AP 115.

After receiving the multi-Wi-Fi capability information of client device 125 at stage 710, second method 700 may proceed to stage 720 where first AP 115 may generate a MWDI for client device 125 in response to the multi-Wi-Fi capability information indicating that client device 125 is a multi-Wi-Fi capable device in the first association request. If client device 125 indicates that that the MWDI is available, then first AP 115 may use the available MWDI at stage 720.

Once having generated the MWDI at stage 720, second method 700 may proceed to stage 730 where first AP 115 may send the MWDI to client device 125 during a four-way handshake for the first connection. For example, first AP 115 may send the MWDI to client device 125 in a third message (M3) of the four-way handshake for the first connection. The MWDI may be sent in an encrypted IE in the third message (M3).

After sending the MWDI to client device 125 at stage 730, second method 700 may proceed to stage 740 where first AP 115 may receive the MWDI from client device 125 during the four-way handshake for the first connection as an acknowledgement. For example, client device 125 may send the MWDI back to first AP 115 in a fourth message (M4) of the four-way handshake for the first connection as an acknowledgement of having received the MWDI form first AP 115. The MWDI may be sent in an encrypted IE in the fourth message (M4).

Once having received the MWDI from client device 125 at stage 740, second method 700 may proceed to stage 750 where first AP 115 may receive, from client device 125, the multi-Wi-Fi capability information of client device 125 in a second association request for a second connection after establishing the first connection. For example, client device 125 after establishing the first connection, may begin establishing the second connection. To that end, client device 125 may, after selecting a network to connect to, may perform authorization with first AP 115 and then send an association request. Client device 125 may also send the multi-Wi-Fi capability information of client device 125 in the association request to first AP 115. The multi-Wi-Fi capability information may be sent in an encrypted IE that may be vendor specific. First AP 115 may also receive information regarding availability of an MWDI in the association frame of the second connection. For example, client device 125 may send an MWDI, if available, in the association frame of the second connection to first AP 115.

After receiving the multi-Wi-Fi capability information of client device 125 in the second association request at stage 750, second method 700 may proceed to stage 760 where first AP 115 may generate another MWDI for client device 125 in response to determining that client device 125 is a multi-Wi-Fi capable device from the multi-Wi-Fi information in the second association request. If client device 125 indicates that that the MWDI is available, then first AP 115 may use the available MWDI at stage 760.

Once having generated the another MWDI at stage 760, second method 700 may proceed to stage 770 where first AP 115 may send the another MWDI to client device 125 during a four-way handshake for the second connection. Client device 125 may be configured to determine whether to use the another MWDI for the second connection. For example, first AP 115 may send the MWDI to client device 125 in a third message (M3) of the four-way handshake for the first connection. The MWDI may be sent in an encrypted IE in the third message (M3). Client device 125 may check a data base at to determine whether client device 125 already as an existing MWDI. Client device 125 may have an existing MWDI in its data base from the primary connection. If client device 125 already has an existing MWDI in the data base, then client device 125 may ignore the another MWDI received from first AP 115 in the third message (M3) of the four-way handshake for the second connection. If client device 125 does not have an existing MWDI in the data base, then client device 125 may update the data base with he another MWDI received from first AP 115 in the third message (M3) of the four-way handshake for the second connection.

After sending the another MWDI to client device 125 at stage 770, first AP 115 may receive the MWDI in a fourth message (M4) of the four-way handshake for the first connection as an acknowledgement of having received the MWDI form first AP 115. The MWDI may be sent in an encrypted IE in the fourth message (M4). First AP 115 may be configured to determine, based on the MWDI, that both the first connection and the second connection are originating from a same client device 125 and apply a policy applied to the first connection also to the second connection. After applying the same policy to the second connection that was applied to the first connection, second method 700 may terminate at END stage 780.

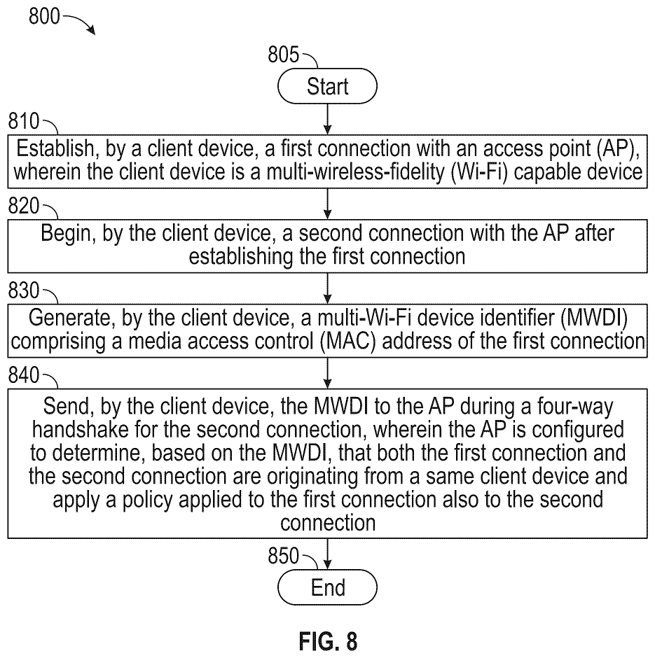

FIG. 8 is a flow chart setting forth the general stages involved in a third method 800 consistent with implementations of the disclosure for uniquely identifying an endpoint that connects to a network using multiple channel/bands. Third method 800 may be implemented using first AP 115 and client device 125 as described in more detail above with respect to FIG. 1 and FIG. 2. Ways to implement the stages of third method 800 will be described in greater detail below.

Third method 800 may begin at starting block 805 and proceed to stage 810 where client device 125 may establish a first connection with first AP 115. As discussed above, client device 125 may be a multi-Wi-Fi capable device. Client device 125 may establish the first connection using first network stack 210 over a first frequency band. First AP 115 may apply a policy for the first connection. The policy may include a QoS level determined for client device 125. The QoS level may be predetermined or defined by a network administrator.

After establishing the first connection at stage 810, third method 800 may proceed to stage 820 where client device 125 may begin a second connection with first AP 115 after establishing the first connection. The second connection may be begun using second network stack 220 over a second frequency band. The second frequency band may be different from the first frequency band. In some examples, the second connection may be formed with a second network. The second network may be different from a first network with which the first connection may be established.

Once having begun the second connection at stage 820, third method 800 may proceed to stage 830 where client device 125 may generate the MWDI comprising a MAC address of the first connection. The MAC address for the first connection may be the MAC address associated with first MAC layer 240a of first network stack 210 of client device 125. Thus, the MWDI may be of 6 bytes.

After generating the MWDI at stage 830, third method 800 may proceed to stage 840 where client device 125 may send the MWDI to first AP 115 during a four-way handshake for the second connection. Client device 125 may send the MWDI in the fourth message (M4) of the four-way handshake of the second connection. The MWDI may be included in an encrypted IE, for example, an encrypted CCX MWDI IE. First AP 115 may be configured to determine, based on the MWDI, that both the first connection and the second connection are originating from a same client device 125 and apply a policy applied to the first connection also to the second connection. After applying the same policy to the second connection that was applied to the first connection, third method 800 may terminate at END stage 850.

FIG. 9 shows computing device 900. As shown in FIG. 9, computing device 900 may include a processing unit 910 and a memory unit 915. Memory unit 915 may include a software module 920 and a database 925. While executing on processing unit 910, software module 920 may perform, for example, device authentication sequences as described above with respect to FIG. 3, FIG. 4, and FIG. 5. In addition, while executing on processing unit 910, software module 920 may perform, for example, methods to uniquely identify an endpoint that connects to a network using multiple channel/bands as described above with respect to FIG. 6, FIG. 7, and FIG. 8. Computing device 900, for example, may provide an operating environment for controller 105, first AP 115, second AP 120, and client device 125. Controller 105, first AP 115, second AP 120, and client device 125 may operate in other environments and are not limited to computing device 900.

Computing device 900 may be implemented using a Wi-Fi access point, a tablet device, a mobile device, a smart phone, a telephone, a remote control device, a set-top box, a digital video recorder, a cable modem, a personal computer, a network computer, a mainframe, a router, a switch, a server cluster, a smart TV-like device, a network storage device, a network relay device, or other similar microcomputer-based device. Computing device 900 may comprise any computer operating environment, such as hand-held devices, multiprocessor systems, microprocessor-based or programmable sender electronic devices, minicomputers, mainframe computers, and the like. Computing device 900 may also be practiced in distributed computing environments where tasks are performed by remote processing devices. The aforementioned systems and devices are examples, and computing device 900 may comprise other systems or devices.

Implementations of the disclosure, for example, may be implemented as a computer process (method), a computing system, or as an article of manufacture, such as a computer program product or computer readable media. The computer program product may be a computer storage media readable by a computer system and encoding a computer program of instructions for executing a computer process. The computer program product may also be a propagated signal on a carrier readable by a computing system and encoding a computer program of instructions for executing a computer process. Accordingly, the present disclosure may be embodied in hardware and/or in software (including firmware, resident software, micro-code, etc.). In other words, implementations of the present disclosure may take the form of a computer program product on a computer-usable or computer-readable storage medium having computer-usable or computer-readable program code embodied in the medium for use by or in connection with an instruction execution system. A computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific computer-readable medium examples (a non-exhaustive list), the computer-readable medium may include the following: an electrical connection having one or more wires, a portable computer diskette, a random access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

While certain implementations of the disclosure have been described, other implementations may exist. Furthermore, although implementations of the present disclosure have been described as being associated with data stored in memory and other storage mediums, data can also be stored on or read from other types of computer-readable media, such as secondary storage devices, like hard disks, floppy disks, or a CD-ROM, a carrier wave from the Internet, or other forms of RAM or ROM. Further, the disclosed methods' stages may be modified in any manner, including by reordering stages and/or inserting or deleting stages, without departing from the disclosure.

Furthermore, implementations of the disclosure may be practiced in an electrical circuit comprising discrete electronic elements, packaged or integrated electronic chips containing logic gates, a circuit utilizing a microprocessor, or on a single chip containing electronic elements or microprocessors. Implementations of the disclosure may also be practiced using other technologies capable of performing logical operations such as, for example, AND, OR, and NOT, including but not limited to, mechanical, optical, fluidic, and quantum technologies. In addition, implementations of the disclosure may be practiced within a general purpose computer or in any other circuits or systems.

Implementations of the disclosure may be practiced via a system-on-a-chip (SOC) where each or many of the element illustrated in FIG. 1 may be integrated onto a single integrated circuit. Such an SOC device may include one or more processing units, graphics units, communications units, system virtualization units and various application functionality all of which may be integrated (or “burned”) onto the chip substrate as a single integrated circuit. When operating via an SOC, the functionality described herein with respect to implementations of the disclosure, may be performed via application-specific logic integrated with other components of computing device 900 on the single integrated circuit (chip).

Implementations of the present disclosure, for example, are described above with reference to block diagrams and/or operational illustrations of methods, systems, and computer program products according to implementations of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

While the specification includes examples, the disclosure's scope is indicated by the following claims. Furthermore, while the specification has been described in language specific to structural features and/or methodological acts, the claims are not limited to the features or acts described above. Rather, the specific features and acts described above are disclosed as example for implementations of the disclosure.

What is claimed is:

1. A method comprising:
beginning, by a client device, a first connection with an Access Point (AP), wherein the client device is a multi-Wireless-Fidelity (Wi-Fi) capable device;
generating, by the client device, a Multi-Wi-Fi Device Identifier (MWDI);
sending, by the client device, the MWDI to the AP during a four-way handshake for the first connection;
beginning, by the client device, a second connection with the AP after establishing the first connection; and
sending, by the client device, the MWDI to the AP during a four-way handshake for the second connection, wherein the AP is configured to determine, based on the MWDI, that both the first connection and the second connection are originating from a same client device and apply a policy applied to the first connection also to the second connection in response to determining that both the first connection and the second connection are originating from the same client device.

2. The method of claim 1, wherein the first connection operates in a first frequency band and the second connection operates in a second frequency band, the second frequency band being different from the first frequency band.

3. The method of claim 1, wherein the first connection is formed using a first network stack and the second connection is formed using a second network stack.

4. The method of claim 1, sending the MWDI to the AP during the four-way handshake for the first connection comprises sending the MWDI to the AP in a fourth message of the four-way handshake for the first connection.

5. The method of claim 1, wherein the four-way handshake comprises an Extensible Authentication Protocol over Local Area Network (LAN) (EAPOL) handshake.

6. The method of claim 1, wherein sending the MWDI to the AP during the four-way handshake for the first connection comprises sending the MWDI in an encrypted information element in a fourth message of the four-way handshake for the first connection.

7. The method of claim 1, wherein the first connection is associated with a first network and the second connection is associated with a second network, the second network being different from the first network.

8. A method comprising:
receiving, by an Access Point (AP) from a client device, multi-Wireless-Fidelity (Wi-Fi) capability information of the client device in a first association request for a first connection;
generating, by the AP, a Multi-Wi-Fi Device Identifier (MWDI) for the client device in response to the multi-Wi-Fi capability information indicating that the client device is a multi-Wi-Fi capable device in the first association request;
sending, by the AP, the MWDI to the client device during a four-way handshake for the first connection;
receiving, by the AP, the MWDI from the client device during the four-way handshake for the first connection as an acknowledgement;
receiving, by the AP from the client device, the multi-Wi-Fi capability information of the client device in a second association request for a second connection after establishing the first connection;
generating, by the AP, another MWDI for the client device in response to determining that the client device is a multi-Wi-Fi capable device from the multi-Wi-Fi information in the second association request; and
sending, by the AP, the another MWDI to the client device during a four-way handshake for the second connection, wherein the client device is configured to determine whether to use the another MWDI for the second connection.

9. The method of claim 8, wherein the client device being configured to determine whether to use the another MWDI for the second connection comprises the client device being configured to update a local data base with if the another MWDI when the MWDI is not available at the client device.

10. The method of claim 8, further comprising:
receiving, by the AP, the MWDI from the client device during the four-way handshake for the second connection.

11. The method of claim 10, further comprising:
determining, by the AP, that the second connection is also originating from a same client device as the first connection based on the MWDI received in during the four-way handshake for the second connection; and
applying, by the AP, a policy applied to the first connection also to the second connection in response to determining that the second connection is also originating from the same client device as the first connection.

12. The method of claim 10, wherein receiving the MWDI from the client device during the four-way handshake for the second connection comprises receiving the MWDI from the client device in a fourth message of the four-way handshake for the second connection.

13. The method of claim 8, wherein the first connection operates in a first frequency band and the second connection operates in a second frequency band, the second frequency band being different from the first frequency band.

14. The method of claim 8, wherein:
sending the MWDI to the client device during the four-way handshake for the first connection comprises sending the MWDI to the client device in a third message of the four-way handshake for the first connection; and
receiving the MWDI from the client device during the four-way handshake for the first connection comprises receiving the MWDI from the client device in a fourth message of the four-way handshake for the first connection.

15. A method comprising:
establishing, by a client device, a first connection with an Access Point (AP), wherein the client device is a multi-Wireless-Fidelity (Wi-Fi) capable device;
beginning, by the client device, a second connection with the AP after establishing the first connection;
generating, by the client device, a multi-Wi-Fi Device Identifier (MWDI) comprising a Media Access Control (MAC) address of the first connection; and
sending, by the client device, the MWDI to the AP during a four-way handshake for the second connection, wherein the AP is configured to determine, based on the MWDI, that both the first connection and the second connection are originating from a same client device and apply a policy applied to the first connection also to the second connection.

16. The method of claim 15, wherein sending the MWDI to the AP during the four-way handshake for the second connection comprises sending the MWDI to the AP in a fourth message of the four-way handshake for the second connection.

17. The method of claim 15, wherein sending the MWDI to the AP during the four-way handshake for the second connection comprises sending the MWDI in an encrypted information element in a fourth message of the four-way handshake.

18. The method of claim 15, wherein the first connection operates in a first frequency band and the second connection operates in a second frequency band, the second frequency band being different from the first frequency band.

19. The method of claim 15, wherein the first connection is associated with a first network and the second connection is associated with a second network, the second network being different from the first network.

20. The method of claim 15, wherein the policy comprises Quality of Service (QoS) parameters.
